(19) United States
(12) Patent Application Publication
(10) Pub. No.: US 2012/0034819 A1
(43) Pub. Date: Feb. 9, 2012

(54) Micro Universal Serial Bus Adapter

(75) Inventor: Henry Chen, Arcadia, CA (US)

(73) Assignee: EVER WIN INTERNATIONAL CORPORATION, City of industry, CA (US)

(21) Appl. No.: 12/850,890

(22) Filed: Aug. 5, 2010

(51) Int. Cl. H01R 27/02

(52) U.S. Cl. 439/638

(57) ABSTRACT

A micro universal serial bus adapter to enable a micro universal serial bus connector to be connected to an Apple proprietary connector. The micro universal serial bus adapter comprises of an adapter that has a male proprietary connector at one end to connect to a female Apple proprietary connector and a female micro universal serial bus connector at the other end to connect to a standard male micro universal serial bus plug.

### BACKGROUND-FIELD OF INVENTION

The present invention relates generally to an adapter to convert one connector type to another connector type. More specifically, the present invention relates to an adapter to convert a proprietary connector to a micro universal serial bus connector.

### BACKGROUND-DESCRIPTION OF RELATED ART

Apple Inc. in Cupertino, Calif., manufactures and markets various popular electronic devices that use Apple's proprietary connectors for data transfer and recharging of the rechargeable battery in these electronic devices. The proprietary connectors are rectangular shaped and the external dimensions are approximately 21 mm wide and 2.4 mm thick. The proprietary connectors may have 10 to 30 contact pins. The proprietary connectors on these electronic devices require corresponding proprietary connectors to connect with them.

A micro universal serial bus (micro USB) female connector is approximately 7.4 mm wide and 2 mm thick. The micro USB female connector may have 5 contact pins or 12 contact pins. The micro USB female connector requires a standard micro USB male connector to connect with it. Micro USB is an industry standard connector that is widely used for various electronic devices.

Apple's proprietary connector is not compatible with the standard micro USB connector. The lack of compatibility gives rise to an unfulfilled demand for a compact and easy to use adapter to enable the use of the common micro USB connector with Apple's proprietary connector.

### BRIEF SUMMARY OF THE INVENTION

The micro universal serial bus adapter of the present invention is an adapter to enable a micro universal serial bus connector to be connected to an Apple proprietary connector. The micro universal serial bus adapter of the present invention comprises of an adapter that has a male proprietary connector at one end to connect to a female Apple proprietary connector and a female micro universal serial bus connector at the other end to connect to a standard male micro universal serial bus plug.

An object of the micro universal serial bus adapter is to provide an adapter from a proprietary connector to a standard micro USB. A further object of the micro universal serial bus adapter is to provide a compact and portable adapter to enable use of the standards micro USB connector with Apple's proprietary connector.

### BRIEF DESCRIPTION OF THE DRAWINGS

FIG. 1 shows a perspective view of the preferred embodiment of the micro universal serial bus adapter.

FIG. 2 shows an exploded perspective view of the preferred embodiment of the micro universal serial bus adapter.

FIG. 3 shows the top view of the preferred embodiment of the micro universal serial bus adapter.

FIG. 4 shows the front view of the preferred embodiment of the micro universal serial bus adapter.

FIG. 5 shows the bottom view of the preferred embodiment of the micro universal serial bus adapter.

FIG. 6 shows the left side view of the preferred embodiment of the micro universal serial bus adapter.

FIG. 7 shows the right side view of the preferred embodiment of the micro universal serial bus adapter.

FIG. 8 shows the rear view of the preferred embodiment of the micro universal serial bus adapter.

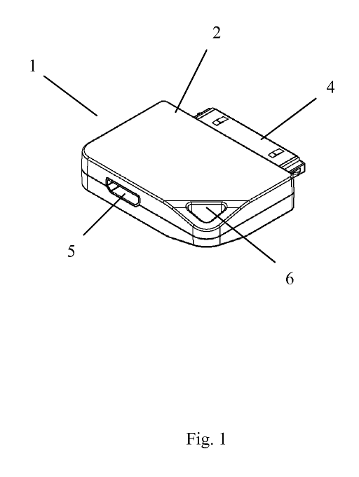

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

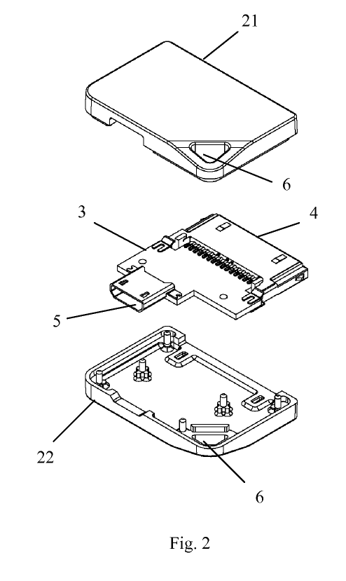

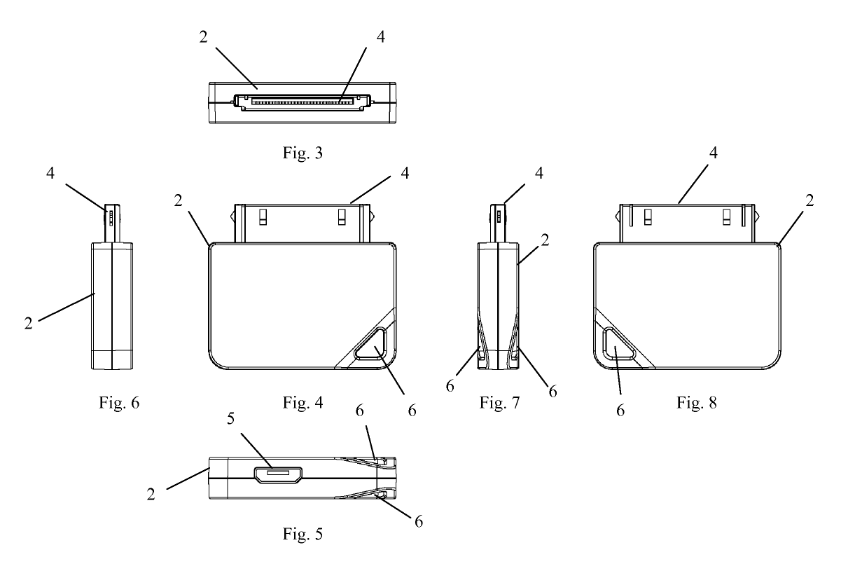

In the preferred embodiment shown in the figures, the micro universal serial bus adapter 1 comprises of a housing 2, preferably made of a plastic material such as ABS plastic. The housing 2 may be comprised of two halves, a upper half 21 and a lower half 22 as shown in FIG. 2. A printed circuit board (PCB) 3 is affixed within the housing 2. A male Apple proprietary connector 4 is affixed to one end of the PCB 3 and a female micro USB connector 5 is affixed to the other end of the PCB 3. The Apple proprietary connector 4 is electrically connected to the micro USB 5 through the PCB 3. The male Apple proprietary connector 4 extends outside of the housing 2 and is insertable into a female Apple proprietary connector in a portable electronic device. The female micro USB connector 5 is positioned inside the housing 2 and is able to receive a male micro USB connector.

In one embodiment of the micro universal serial bus adapter 1, the housing 2 has an opening 6 near one corner for the attachment of a keychain or a strap. The opening 6 may be in the form of a rounded triangle with the housing 2 sloping to a narrower edge near the corner of the housing 2. The opening 6 enables the attachment of a keychain or a strap for convenient carrying of the micros universal serial bus adapter 1.

The micro universal serial bus adapter 1 provides a compact and portable adapter to enable connection of a micro USB cable to a proprietary Apple connector. The micro universal serial bus adapter 1 of the present invention enables a portable electronic device with a proprietary Apple connector to connect to a standard micro USB for charging and data transfers. The micro universal serial bus adapter 1 eliminates the necessity of a proprietary connector and cable for the portable electronic devices and enables the use of common standard micro USB connector and cable.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A micro universal serial bus adapter comprising:
a housing;
a printed circuit board enclosed in said housing;
a proprietary connector electrically connected to said printed circuit board; and
a micro universal serial bus connector electrically connected to said printed circuit board;
wherein electrical connections are established between said proprietary connector and said micro universal serial bus connector.

2. A micro universal serial bus adapter as in claim 1 wherein said housing comprises of an upper half housing and a lower half housing.

3. A micro universal serial bus adapter as in claim 2 wherein said housing is made of a plastic material.

4. A micro universal serial bus adapter as in claim 3 wherein said plastic material is ABS.

5. A micro universal serial bus adapter as in claim 1 wherein said proprietary connector is an Apple proprietary connector.

6. A micro universal serial bus adapter as in claim 1 wherein said housing defines an opening near a corner of said housing.

7. A micro universal serial bus adapter as in claim 2 wherein said housing defines an opening near a corner of said housing.

8. A micro universal serial bus adapter comprising:
a plastic housing comprising an upper half housing and a lower half housing;
a printed circuit board enclosed in said housing;
an Apple proprietary connector electrically connected to said printed circuit board; and
a micro universal serial bus connector electrically connected to said printed circuit board;
wherein electrical connections are established between said Apple proprietary connector and said micro universal serial bus connector.

9. A micro universal serial bus adapter as in claim 8 wherein said housing defines an opening near a corner of said housing.
